(19) United States
(12) Patent Application Publication
(10) Pub. No.: US 2015/0358403 A1
(43) Pub. Date: Dec. 10, 2015

(54) METHOD, SYSTEM, APPARATUS AND COMPUTER PROGRAM PRODUCT FOR COMMUNICATION MANAGEMENT

(71) Applicants: Tero BODSTRÖM, Tampere (FI); Mattipekka KRONQVIST, Kangasala (FI)

(72) Inventors: Tero BODSTRÖM, Tampere (FI); Mattipekka KRONQVIST, Kangasala (FI)

(73) Assignee: Eye Solutions Oy, Tampere (FI)

(21) Appl. No.: 14/410,117

(22) PCT Filed: Jun. 21, 2012
(86) PCT No.: PCT/FI2012/050651

§ 371 Date: Feb. 17, 2015

(51) Int. Cl. H04L 29/08

(52) U.S. Cl. CPC H04L 67/1051

(57) ABSTRACT

A method for controlling communications in a communications system includes operating a client device in the communications system; communicating by a first master device with the at least one client device; and executing a communication management service in the first master device for controlling communications between the first master device and the at least one client device. The communication management service instructs the first master device to transmit identification information of the first master device for reception by the at least one client device to inform the at least one client device the identity of the first master device. A server, a client for the system, and a computer program product are also included The master device may also manage bandwidth provided to the client devices. The bandwidth management may take into account the priority of messages from client devices, the overall bandwidth available at the region, etc.

### FIELD OF THE INVENTION

The present invention relates to a method for controlling communication management in a communication system. The invention also relates to a system comprising means for managing communication in the system. The invention further relates to an apparatus comprising means for managing communication in a communication system.

### BACKGROUND OF THE INVENTION

Portable communication devices exist which are able to establish a local communications system for a dedicated purpose when two or more such communication devices are within an operation range of the communication elements of the communication devices. In other words, the operation range can be regarded as an area in which the communication devices are able to transmit and receive data with other communication devices of the communication system. It should, however, be noted here that each communication device operating in the local communications system need not be able to directly communicate with every other communication device of the local communications system but it may be sufficient when two communication devices may communicate with each other via one or more other communication devices in the local communications system or via a wireless communication network such as a WLAN (a wireless local area network), the GSM (Global System for Mobile communications) network or the UMTS (Universal Mobile Telecommunications System) network.

Moreover, the term “local communications system” should not be limited to systems covering an area of a certain relatively small range but the operational area of local communications systems may vary from a few meters to even hundreds of kilometres. For example, in some local communications systems the operational area may cover a building, in some other local communications systems the operational area may be of the order of some tens or hundreds of meters. Furthermore, in some other examples the operational area of a local communications systems may reach an area of a city or even an area of a country.

Local communications systems may be a so called ad-hoc networks in which any communication device may be able to establish a local communications network in which other communication devices within the operational area may be able to connect. In some other examples the local communications system may be established by defining a master communication device and one or more client communication devices. If a new client communication device should be added to such a local communications system it may be necessary to configure the master communication device and/or the new client communication device so that the new client communication device is able to communicate with the local communications system.

Systems in which only one communication device is dedicated as a master device may become inoperable if the master device breaks down, runs out of battery or for some other reason is not capable of communicating and controlling communications in the system. This may not be acceptable especially in critical networks serving as emergency communications networks, military networks etc.

When more communication devices are added to the communication system the more communication capacity may be needed to enable proper communication between communication devices of the local communications system. This communication capacity may also be called as a bandwidth in this application meaning that the more bandwidth is provided the more information can be transferred between communication devices. However, there may be situations in which adding bandwidth is not always possible due to different reasons. For example, the radio spectrum utilizable by the local communications system may be limited and thus may restrict the maximum available bandwidth.

When the bandwidth is too limited it may happen that a critical message from one communication device to another communication device in the communication system may be delayed due to lack of communication resources and may affect that operations to correct the reason behind the critical message may be started too late.

Based on the above, there is a need for an improved solution which enables to manage communications in a communications system so that the communications system remains operable even if one or more communication devices become inoperable and an available bandwidth can be utilized in an efficient manner.

### SUMMARY OF THE INVENTION

One aim of the present invention is to provide a method for controlling communications management in a communications system more efficiently than in existing local communications systems. In some embodiments there is provided a communication management service which is able to control communication between communication devices of a group. The communication management service may be installed in a multiple of communication devices which form a group and the communication devices may be hierarchically organized so that one of the communication devices operates as a master device and if it fails, the hierarchy can be used to determine which other communication device of the group should become a new master device. In some embodiments the communication management service may also be called as a mission console service.

In some embodiments the master device may also monitor communication activity in the area of the master device to determine how much communication capacity can be used by the system. The master device may then provide more communication capacity (bandwidth) to client devices having higher priority communication tasks pending and less communication capacity to other client devices. The communication capacity provided to client devices may also vary from time to time. Hence, the master device may manage the bandwidth used by the system by providing appropriate communication capacity for the client devices.

According to a first aspect of the invention, there is provided a method for controlling communications in a communications system comprising:
operating at least one client device in the communications system;
communicating by a first master device with the at least one client device;
executing a communication management service in the first master device for controlling communications between the first master device and the at least one client device;
wherein the communication management service instructs the first master device to transmit identification information of the first master device for reception by the at least one client device to inform the identity of the first master device to the at least one client device.

In some embodiments, the identification information of the first master device is transmitted at intervals. wherein the at least one client device not receiving the identification information within a predetermined period tries to receive identification information of another master device.

In some embodiments the client device not receiving the identification information within a predetermined period compares the identification information of the another device of an identification information of the client device to determine if the client device should become a new master device.

In some embodiments the client device which becomes the new master device begins to transmit the identification information of the client device to inform other client devices that the client device is the new master device.

In some embodiments the method comprises defining a device hierarchy comprising at least a first level and a second level, wherein devices are assigned to at least one level of the device hierarchy.

In some embodiments the master device operates in the second level and the client devices operate in the first level.

In some embodiments the device hierarchy further comprises a third level, wherein a second master device is operating on the third level and communicates with master devices on the second level.

In some embodiments the first master device receives status information from the client devices; uses the received status information to form a combined information; and provides the combined information to the second master device.

In some embodiments the first master device sends a command to the at least one client device to control the operation of the at least one client device.

In some embodiments the first master device manages bandwidth provided to the at least one client device.

In some embodiments the bandwidth management comprises at least one of the following:
examining a priority of a request from the at least one client device;
examining the bandwidth available for the communications in the communications system between the first master device and the at least one client device;
adapting the amount of information to be sent from the at least one client device to the first master device.

According to a second aspect of the invention there is provided a system for controlling communications, the system comprising:
at least one client device comprising communication means to communicate with a first master device;
the first master device comprising communication means to communicate with the at least one client device;
means for executing a communication management service in the first master device for controlling communications between the first master device and the at least one client device;
wherein the communication management service comprises means for instructing the first master device to transmit identification information of the first master device for reception by the at least one client device to inform the identity of the first master device to the at least one client device.

In some embodiments the system further comprises:
means for transmitting at intervals the identification information of the first master device. wherein the at least one client device not receiving the identification information within a predetermined period is adapted to try to receive identification information of another master device.

In some embodiments the client device not receiving the identification information within a predetermined period is adapted to compare the identification information of the another device of an identification information of the client device to determine if the client device should become a new master device.

In some embodiments the client device which becomes the new master device is adapted to begin transmitting the identification information of the client device to inform other client devices that the client device is the new master device.

In some embodiments the system further comprises means for defining a device hierarchy comprising at least a first level and a second level, wherein devices have been assigned to at least one level of the device hierarchy.

In some embodiments the master device is adapted to operate in the second level and the client devices are adapted to operate in the first level.

In some embodiments the device hierarchy further comprises a third level, wherein a second master device is adapted to operate on the third level and to communicate with master devices on the second level.

In some embodiments the first master device comprises:
means for receiving status information from the client devices;
means for using the received status information to form a combined information; and
means for providing the combined information to the second master device.

In some embodiments the first master device is adapted to send a command to the at least one client device to control the operation of the at least one client device.

In some embodiments of the system the first master device comprises means for managing bandwidth provided to the at least one client device.

In some embodiments the means for managing bandwidth comprises at least one of the following:
means for examining a priority of a request from the at least one client device;
means for examining the bandwidth available for the communications in the communications system between the first master device and the at least one client device;
means for adapting the amount of information to be sent from the at least one client device to the first master device.

According to a third aspect of the invention there is provided a master device for a communication system. The master device comprises:
a transceiver for receiving and transmitting data to and from at least one client device;
means for executing a communication management service for controlling communications between the master device and the at least one client device;
the communication management service comprising means for transmitting identification information of the master device for reception by the at least one client device to inform the identity of the master device to the at least one client device.

In some embodiments the master device is adapted to transmit at intervals the identification information of the master device.

In some embodiments the master device further comprises means for determining a device hierarchy comprising at least a first level and a second level, and means for using the device hierarchy to determine which client devices belong to a set of client devices the master device is configured to control.

In some embodiments the master device is adapted to operate in the second level.

In some embodiments the device hierarchy further comprises a third level, wherein the master device is adapted to communicate with a master device of the second level.

In some embodiments the first master device comprises:
means for receiving status information from the client devices;
means for using the received status information to form a combined information; and
means for providing the combined information to the master device of the second level.

In some embodiments the first master device is adapted to send a command to the at least one client device to control the operation of the at least one client device.

In some embodiments the first master device comprises means for managing bandwidth provided to the at least one client device.

In some embodiments the means for managing bandwidth comprises at least one of the following:
means for examining a priority of a request from the at least one client device;
means for examining the bandwidth available for the communications in the communications system between the first master device and the at least one client device;
means for adapting the amount of information to be sent from the at least one client device to the first master device.

According to a fourth aspect of the invention there is provided a client device for a communication system. The client comprises:
a transceiver for receiving and transmitting data to and from a master device;
means for sending a request for communication to a server; and
means for receiving identification information of the master device to determine the identity of the master device.

In some embodiments the client device is adapted to receive the identification information of the master device at intervals.

In some embodiments the client device further comprises means for determining a device hierarchy comprising at least a first level and a second level, and means for using the device hierarchy to determine which master device is configured to control the client device.

In some embodiments the client device is adapted to operate in the first level.

In some embodiments the client device is adapted to receive a command from the master device to control the operation of the client device.

According to a fifth aspect of the invention there is provided a computer program product comprising a computer-readable medium bearing computer program code embodied therein for use with a computer, the computer program code comprises code for performing the above method.

It is possible to combine one or more of the above embodiments to provide a further embodiment of the invention.

Advantages of various embodiments of the invention comprise the ability to construct a large hierarchical communications system and assign different roles to communication devices of the communications system.

### DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1a illustrates a hierarchy of a part of a military organization according to one example embodiment of the present invention;

FIG. 1b illustrates as a simplified block diagram a communications system according to one example embodiment of the present invention;

FIG. 1c illustrates a part of the communications system of FIG. 1b according to one example embodiment of the present invention;

FIG. 2a discloses a block diagram of a communication device for the system according to one embodiment of the invention;

FIG. 2b discloses examples of some elements of the communication device of FIG. 2a according to one embodiment of the invention;

FIG. 3a discloses a block diagram of another communication device for the system according to one embodiment of the invention;

FIG. 3b discloses examples of some elements of the communication device of FIG. 3a according to one embodiment of the invention;

FIG. 4 illustrates an example of a display in which location of communication devices of a group is shown by a communication device of a leader of the group;

FIG. 5a depicts a flow diagram of a method for determining which communication device is operating as a master device according to one embodiment of the invention; and

FIG. 5b depicts a flow diagram of a method for determining which communication device is operating as a master device according to another embodiment of the invention.

### DETAILED DESCRIPTION OF THE INVENTION

Reference will now be made in detail to some embodiments of the present invention, examples of which are illustrated in the accompanying drawings.

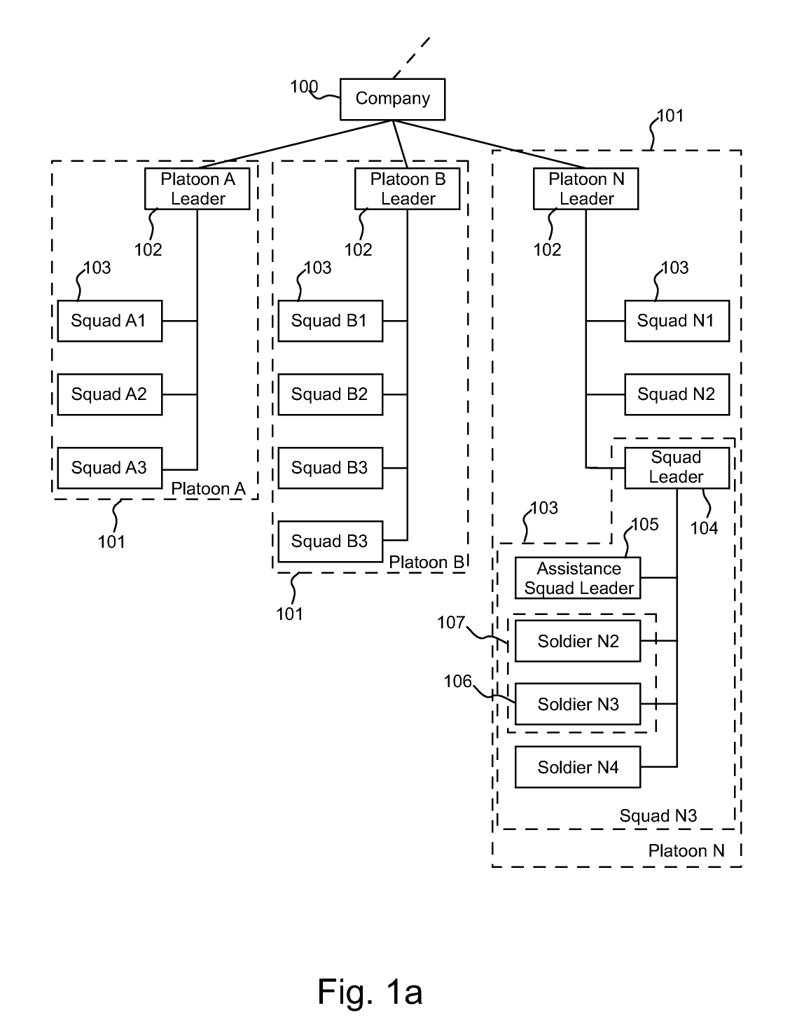

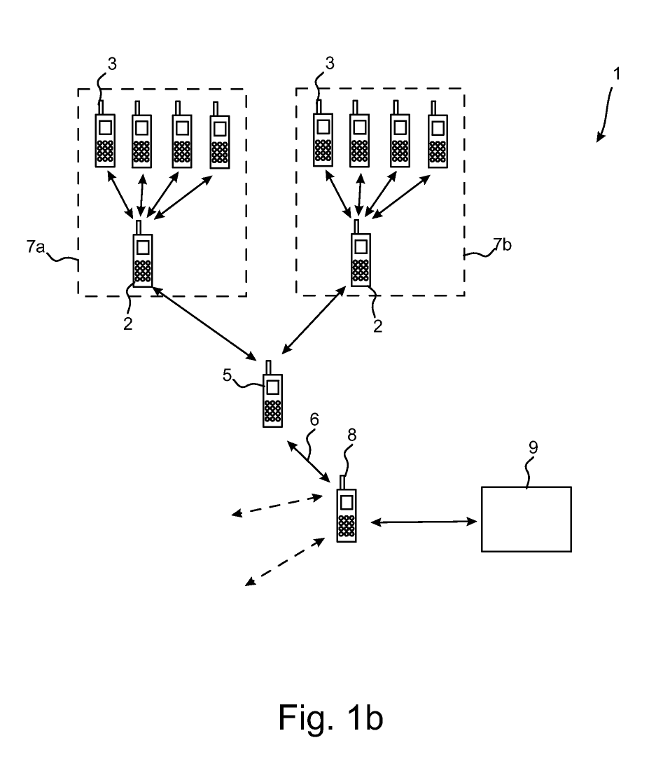

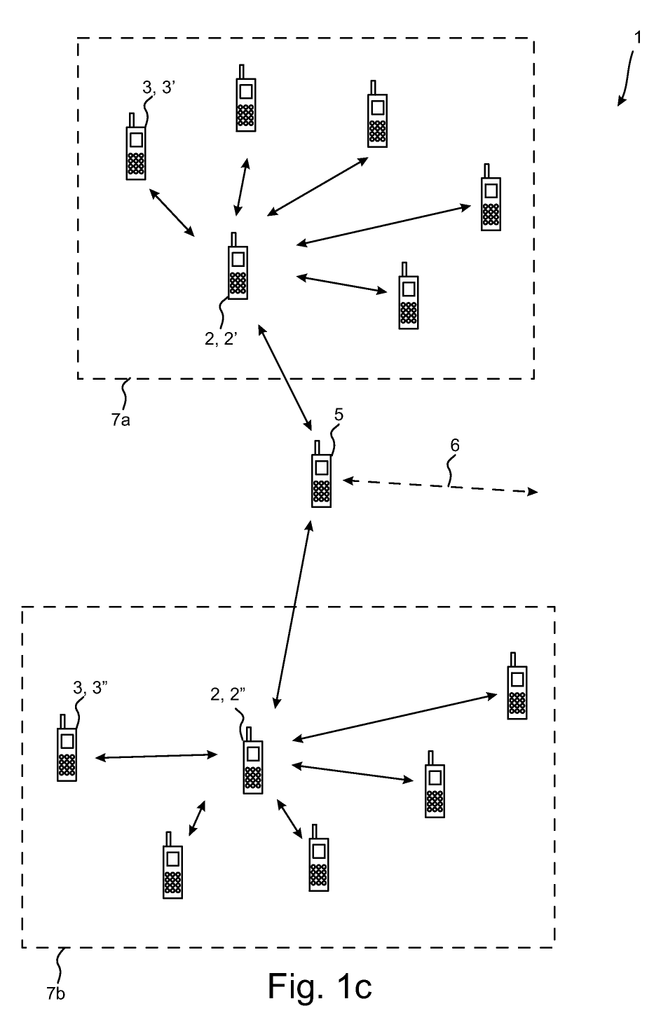

In FIG. 1a a simplified example of a hierarchy of a part of a military organization is illustrated. The military organization is a company 100 which may be part of a battalion (not shown). The company 100 comprises one or more platoons 101. The platoons 101 are further divided into squads 103 which are formed by a group of soldiers 106. In some situations two or more soldiers 106 of a squad may be ordered to form a patrol 107 or a fire team. Squads are led by a squad leader 104 and may be assisted by an assistance squad leader 105. A platoon 101 is commanded by a platoon leader 102. A command chain is usually from top to down i.e. in a company 100 a commander organizes platoons 101 and may give different platoons different tasks or operations. In each platoon 101 the platoon leaders 102 arrange squads 103 so that the tasks or operations would become fulfilled. In squads 103 squad leaders 104 orders soldiers 106.

In FIG. 1a the organization of a squad is only depicted in one squad (the third squad in the Nth platoon) but it is obvious that each squad may be organized in the same way. However, different squads 103 may have different number of soldiers 106 and different platoons 101 may have different number of squads 103.

In one squad 103 the roles of the soldiers 106 within the squad 103 may be predetermined or the roles may be determined when the squad 103 has been established. It is also possible that the structure of squads 103 may change during operation or the roles and tasks of soldiers 106 within the squad 103 may change from time to time, e.g. depending the progress of an operation. It may also happen that the squad leader 104 has to quit from leading the squad 103 wherein the assistance squad leader 105 takes the responsibility to lead the squad 103. Further, if the assistance squad leader 105 can no longer lead the squad 103 the determined hierarchy of the squad defines who of the other soldiers 106 of the squad 103 should take the lead of the squad 103.

In some situations it may also happen that two or more squads 103 are merged wherein the hierarchy and command chains may also change.

In order to efficiently control the operations of the military organization or other organization good communication connections are preferred so that commands from top to bottom are efficiently delivered and information in the traversed direction (i.e. from bottom to top) is obtained reasonably fast and in a compact manner so that information gathered by the soldiers is selectively delivered to higher levels in the hierarchy.

In some embodiments of the present invention the hierarchical structure is built in the communications system which the communication devices use. In the following, this is disclosed in more detail using the system of FIG. 1c and the hierarchical structure of FIG. 1a as an example.

FIG. 1b discloses a system 1 according to one example embodiment of the present invention. The system 1 comprises at least one group 7a, 7b of communication devices 3, which may be operated by soldiers 106 or other persons belonging to the organization. Each group 7a, 7b may comprise one or more communication devices 3. The communication devices of the group 7a, 7b may be similar to each other or there may be different kinds of communication devices in the group. Each communication device 3 has a unique equipment identifier Dev_ID so that each communication device 3 can be distinguished from other communication devices 3. The equipment identifier can also be used in determining the hierarchy between the communication devices 3 as will be described later in this application.

In the example of FIG. 1b two groups 7a, 7b of communication devices are depicted but it is obvious that in practical implementations the number of groups 7a, 7b may be different from two. The first group 7a may belong to, for example, a squad 103 of the organization of FIG. 1a and the second group 7b of communication devices may belong to another squad 103 of the organization. In FIG. 1b it is, however, assumed that both the first group 7a and the second group 7b are part of the same platoon wherein both squad leaders are commanded by the same platoon leader. At the system level this means that the communication device 2 of the squad leader communicates with other communication devices within the same group 7a, 7b and with the communication device 5 of the platoon leader. The communication devices 5 of the platoon leaders may communicate with a communication device 8 of a company commander and the communication device 8 of the company commander may be able to communicate with communication devices of other possible platoon leaders and/or commanders on a higher level (if any) in the organization hierarchy. In the example of FIG. 1b the communication device 8 of the company commander is able to communicate with a central device 9 which may be located e.g. in a headquarters of the organization.

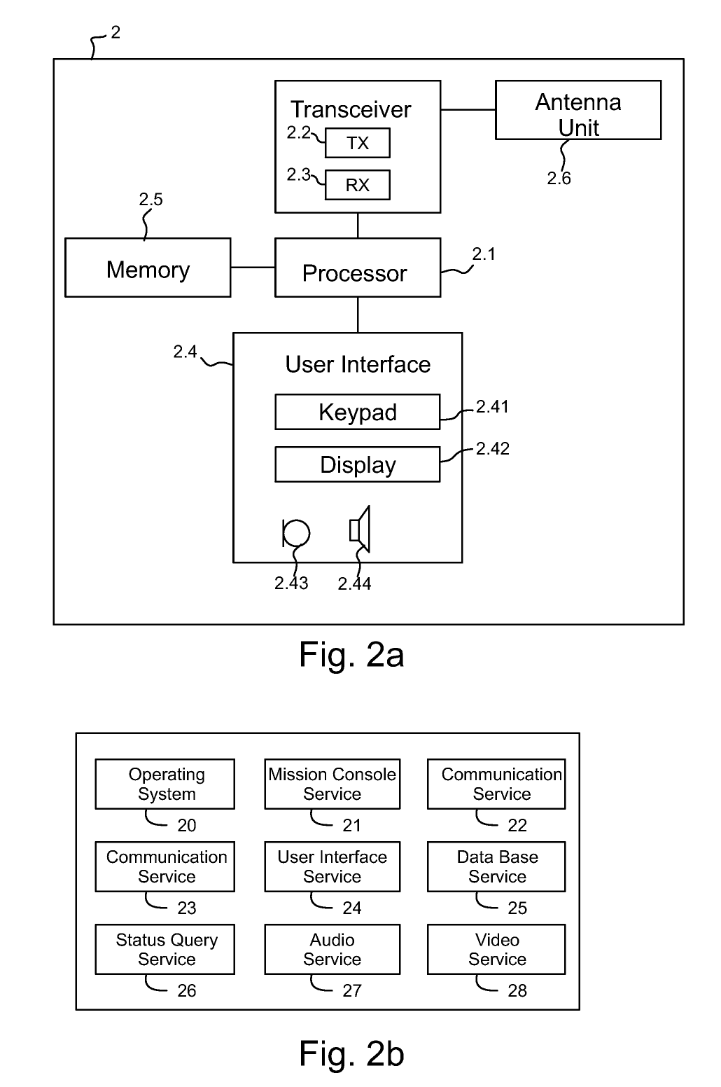

The communication device 2 of the squad leader comprises a mission console service 21 (FIG. 2b) which may be implemented as an element which performs certain tasks and may be activated when the communication device is dedicated to a leader. The mission console service 21 takes care of gathering information from communication devices 3 within the same group and at least partly controlling the communication devices 3 within the same group. Furthermore, the mission console service 21 takes care of communicating with the communication device 5 at the next higher level in the organization hierarchy. In the example of FIGS. 1b and 1c the communication device 5 may belong to the platoon leader wherein the communication device 5 may communicate with a communication device 8 of a company commander. This communication connection is illustrated with arrow 6 in FIGS. 1b and 1c.

For distinguishing communication devices operated by different persons from each other a communication device operated by a leader or a commander can also be called as a master device, and a communication device operated by a group member such as a soldier can also be called as a client device.

The mission console service 21 is also implemented in the communication device 5 of the platoon leader and communication devices at higher levels. In many embodiments the mission console service 21 is further implemented in part of communication devices within the same group 7a, 7b or in all communication devices within the same group 7a, 7b but the mission service 21 may not be running or may be inactive in such communication devices 3 which are not used by a leader or a commander. Providing the mission console service 21 in more than one communication device within the same group enables that another person can take charge of the leading of the group if, for some reason, the leader has to be replaced with another person or if the communication device of the leader has to be replaced with another communication device. This may be implemented e.g. in such a way that each communication device is provided with information on priorities (or a hierarchy) of the identities of the communication devices, information on the group the communication device belongs to, and information on the status of the communication device of the leader and possibly information on the status of other communication devices within the group(s) the communication device belongs to. This may be illustrated as a device table e.g. as follows:

TABLE 1a

| Dev_ID | Group ID | Priority | Status |
|---|---|---|---|
| 1001 | A | 2 | Listening |
| 1002 | A | 1 | Listening |
| 1003 | A | 0 | Listening |
| 1004 | A | 3 | Active |
| 1010 | B | 0 | Active |
| 1011 | B | 1 | Listening |

TABLE 1b

| Dev_ID | Group ID | Priority | Status |
|---|---|---|---|
| 1010 | B | 2 | Active |
| 1012 | B | 1 | Switched Off |
| 1011 | B | 0 | Listening |

In the example of Table 1a it is assumed that the communication device in which the information corresponding with Table 1a is stored can belong to two groups: Group A and Group B. Respectively, In the example of Table 1b it is assumed that the communication device in which the information corresponding with Table 1b is stored belongs to group B only. Dev_ID is the unique identity of the communication device, group ID is an identity of the group to which the communication device belongs, and the priority indicates the hierarchy of the devices within the group. The information provided in the status column can be used to indicate if the communication device is operating as a master device (status=active), as a client device (status=listening), is switched off or for some other reason cannot be detected.

In the example of Tables 1a and 1b the priority is assumed to be the higher the greater the number in the priority column is. For example in Table 1a, the device having priority value 3, i.e. the device in which Dev_ID=1004, is assumed to have the highest priority in Group A and the device having the priority value 1 is assumed to have the highest priority in Group B. It can therefore be assumed that the device having Dev_ID=1004 is a communication device of the leader of Group A if the status of that communication device is active. In other words, that device is operating the master device of Group A.

In some embodiments the device table may also contain an indication if the communication device is allowed to operate as a master device or not. This may be necessary e.g. when not all soldiers in the squad are not allowed to become squad leaders but only an assistance squad leader and possible some other soldier of the squad.

In practice the information provided by the tables 1a and 1b can be implemented and stored in the memory of the communication devices 2, 3 in many different ways.

In the example of Table 1a the communication device having Dev_ID=1001 has the next highest priority wherein if that communication device is operating normally it will begin to operate as the master device. The other communication devices update the table correspondingly and continue operating as client devices.

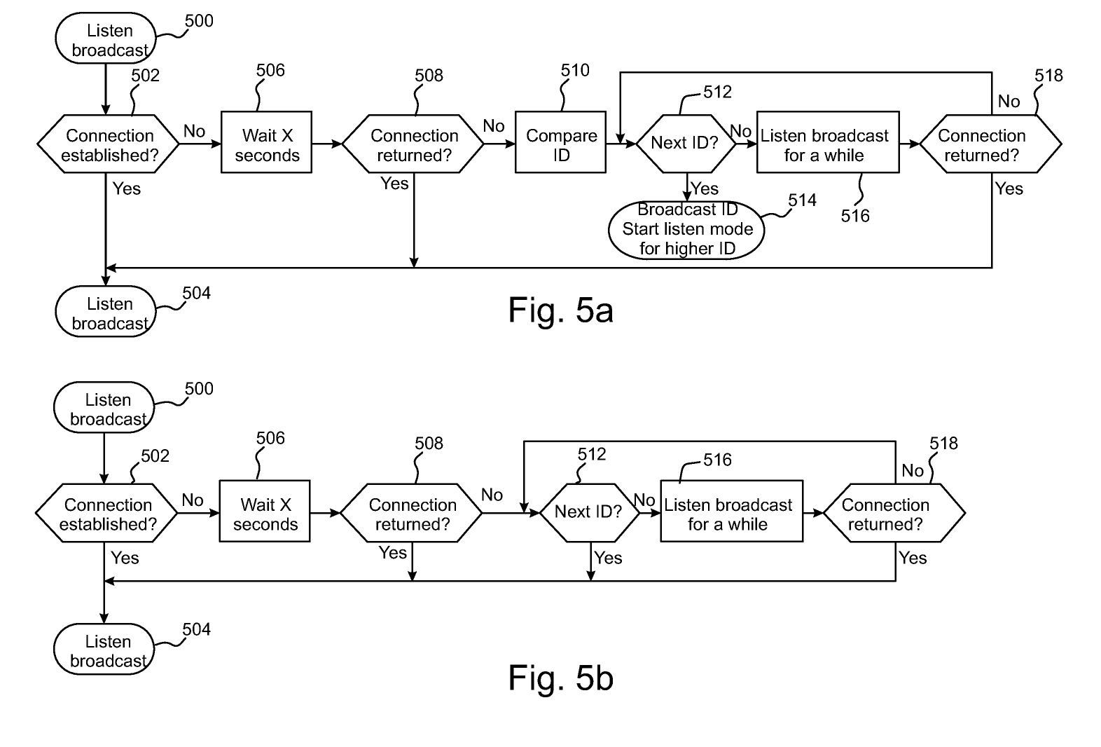

FIG. 5a illustrates as a flow diagram an example of a method for determining which communication device is operating as a master device 2. It is assumed here that the master device periodically transmits a broadcast transmission which the other communication devices of the same group try to receive 500 (i.e. the client devices listen broadcasts from the master device). If the communication device detects a broadcast transmission from the master device, the communication device and the master device try to establish 502 a connection or resume a previously established connection. If the connection can be established the communication device 3 can continue 504 listening broadcast transmissions and assume that no changes to the master device has occurred.

On the other hand, if a connection between the master device and the communication device 3 cannot be established the communication device 3 may wait 506 a predetermined time, e.g. a few seconds, and then tries 508 to establish the connection with the master device 2. If the connection succeeds, the communication device can continue listening broadcasts 504.

If the connection cannot be established, the client device 3 may examine information regarding the latest master device to determine whether the client device should become the new master device or not. The client device 3 may have stored the information regarding the latest master device when the connection with the master device 3 was previously established. The information may include, for example, the equipment identity of the master device and the priority or the hierarchy level of the master device 2. The client device 3 is also provided with similar information regarding the client device itself. Then, the client device may e.g. compare 510 the priority of the master device with the priority of the client device. If the priority of the client device 3 is next 512 in the hierarchy the client device 3 can determine that it should begin operating as the master device. Thus, the client device may change the status of the mission console service 21 to active mode and the client device begins to periodically transmit 514 broadcast messages so that the other communication devices can detect the change of the master device. The communication device also continues to listen possible broadcast messages from other communication devices so that the communication device may detect if there is another communication device which has a higher priority than the communication device itself. This situation may occur e.g. when a new communication device having a higher priority is added to the system or when an existing communication device having a higher priority has been switched on.

If, however, the comparison at step 510 indicates that the priority of the communication device is not the next in the hierarchy the communication device may listen 516 transmissions for a while to detect a possible broadcast transmission from another communication device which is higher in the hierarchy than the communication device. If the broadcast transmission from another communication device having a higher priority was detected and a connection between the communication device and the other communication device could be established or resumed 518, the communication device can continue listening broadcasts 504 i.e. the mission console service of the communication device remains in the listening mode. Otherwise, the communication device selects 512 another equipment identifier from the list and tries to listen 516 if that other communication device is transmitting broadcast messages. If the communication device detects broadcast transmission from the other communication device and if a connection can be established to the other communication device, the operation continues to step 504. Otherwise, a still next equipment identifier may be selected in step 512 until there are no other equipment identifiers in the list (e.g. Table 1a) which relate to devices having higher priority than the communication device itself.

In other words, the operation may continue in the loop of steps 512, 516 and 518 until the communication device has determined that no other communication devices in the same group cannot be communicated with which have a higher priority, wherein the communication device itself should begin operating as the master device.

The waiting time mentioned above in steps 506 and 516 may vary in different implementations and also in different situations. The waiting time may be, for example, one second, five seconds, ten seconds or other appropriate amount of time. The waiting time may also be variable or it may be possible to change by e.g. a control centre of the system. Furthermore, the waiting time in step 506 may be different from the waiting time in step 516. In some embodiments the waiting time in step 516 is shorter than the waiting time in step 506.

The method described above may be performed by the mission console service or by some other service in client devices 3.

FIG. 5b illustrates as a flow diagram another example of a method for determining by a client device 3 which communication device is operating as a master device 2. It is assumed here that the client device 3 is not able to operate as the master device. Hence, the operation may comprise steps similar to the steps in FIG. 5a except that the client device 3 will not begin broadcasting ID messages. Thus, the steps 510 and 514 is missing from this embodiment.

The above described operation is a kind of a watch dog operation in which the master device is assumed to regularly send a message or a signal (e.g. the broadcast message) to client devices and also to a communication device on a higher level wherein each client device and the communication device on the higher level may measure a time from the latest reception of the broadcast message and if the time exceeds a threshold the device may assume that the master device is not operating normally and some of the client devices should begin operating as the master device.

In the above the operations relating to the change of the master device was illustrated with reference to squads but it is obvious that similar operations are also possible at higher levels of the organization hierarchy. For example in the hierarchy of FIG. 1a, the platoon leader (operating the communication device 5 of FIG. 1b) may have to quit wherein some of the squad leaders may become the platoon leader. This could mean that the communication device 2 of the squad leader begins to operate as the master device 5 at the platoon leader level of the organization hierarchy.

In some other embodiments the communication device which will not be able to continue operation as the master device the communication device may inform other communication devices within the group and also the communication device at the next higher level in the hierarchy that the communication device will quit operating as the master device. Then, the other communication devices within the group may perform corresponding operations as described above to determine what communication device will begin to operate as the new master device. Each communication device may, for example, compare its own priority value with the priority value of the previous master device and if the priority value corresponds with the next lower level than the priority of the previous master device the communication device can determine that it should become the new master device. Alternatively, each communication device may examine which equipment identifier Dev_ID has the next lower priority level and compare the equipment identifier Dev_ID with the own equipment identifier of the communication device and if they are the same the communication device can determine that it should become the new master device.

FIG. 1c illustrates some details of the system of FIG. 1b. The system may also comprise a central device 9 which may be called as a server, for example. The central device 5 is configured for inter alia managing many operations of the system and for managing the configuration of the system and maintaining information about devices which belong to the system.

In some embodiments the master device 2 is also able to control at least some resources to be provided to the client devices 3 of the system 1. The master device 2 may be a portable communication device which may be carried by a user of the master device 2 or the master device 2 may be installed or installable to a vehicle 4 such as a military vehicle. Also the client devices 3 may be portable communication devices such as mobile phones or other handheld wireless communication devices. In the system 1 the master device 2 is able to communicate with the client devices 3. In some embodiments the client devices 3 may be able to communicate with other clients 3 of the system either directly or via the server 2 whereas in some other embodiments the client devices 3 are only allowed to communicate with the master device 2 of the group or groups in which the client device belongs.

The communication between the master device 2 and the client devices 3 is wireless communication utilizing some radio communication technology. Because there are many devices 2, 3, 5 in the system 1 which may communicate with other devices even at the same time, some mechanisms are provided to enable the simultaneous communication. For example, the communication may use frequency division multiple access technology (FDMA), time division multiple access technology (TDMA), code division multiple access technology (CDMA), or any other appropriate communication technology.

In some embodiments the communication within the system is encrypted so that eavesdropping of the communications is not possible or at least is made very difficult. There are many appropriate encrypting technologies available which provide efficient enough encryption to the information delivered between devices 2, 3, 5 of the system.

In some embodiments the master device is able to control and manage the client devices 3. For example, the master device 2 may be able to individually change the bandwidth provided to each client 3. The master device 2 may also be able to change tasks (or roles) of the client devices 3 when necessary, as will be described later in this application. The master device 2 may also be able to communicate with the central device 9 of the system.

FIG. 2a depicts a block diagram of an example embodiment of the communication device being able to operate as the master device 2. The communication device 2 comprises a processor 2.1 for controlling the operations of the communication device 2. The communication device 2 also comprises communication means such as a transmitter 2.2 and a receiver 2.3 for communicating with other devices in the system 1. The communication means may also be called as a transceiver. The communication device 2 further comprises a user interface 2.4 for providing means 2.41 to input data (e.g. a keyboard and/or a touch sensitive input element) by a user to the communication device 2 and means 2.42 to display data (e.g. a display) to the user. The user interface 2.4 may also comprise a microphone 2.43 for inputting audio information such as speech, and a loudspeaker 2.44 for providing audio information to the user of the communication device. There is also a memory 2.5 for storing data and program code. The memory 2.5 may comprise different kinds of memory such as volatile memory and non-volatile memory.

The term volatile memory means memory in which information is not maintained if power is switched off from the volatile memory, whereas the term non-volatile memory means memory in which information is maintained at least for a while after switching power off from the non-volatile memory. Some non-volatile memory components may be able to maintain information in the memory months or even years without providing external power to the non-volatile memory component.

In FIG. 2b an example of some further elements of the communication device capable of operating as the master device are depicted as a simplified block diagram. In this example embodiment the master device 2 has an operating system 20, the mission console service 21, a first communication service 22, a second communication service 23, a user interface service 24, a data base service 25, a status query service 26, an audio service 27, and a video service 28. Also other services may be implemented in the communication device. The services may be implemented as a computer instructions which when performed by the processor 2.1 of the communication device cause the communication device to perform steps determined by the computer instructions. The computer instructions may be stored into a memory 2.5 of the communication device. Each of the services may be able to communicate with one or more of the other services or otherwise exchange information. For example, the mission console service 21 may be able to obtain a list of equipment identifiers and corresponding other information from the data base service 25 which may comprise means to store and retrieve such information to/from the memory 2.5 of the communication device. The user interface service 24 is able to receive commands and other information provided by the user of the communication device e.g. by using a keypad 2.41 and/or a touch screen of the communication device. The user interface service 24 is also able to provide information to a display 2.42 and/or to a loudspeaker 2.44 of the communication device.

In some embodiments each communication device may not be able to operate as the master device. Hence, such a communication device may not comprise the mission console service 21 but another service capable of listening broadcasts and communicating with a master device.

It is also possible that many different kinds of communication devices can be used in the system provided that the communication devices comprise enough communication and processing capacity for their intended roles in the system.

In some embodiments the processor 2.1 comprises more than one processor core i.e. the processor 2.1 may be a multi-core processor. Hence, simultaneous processing of two or more threads of computer instructions may be possible to increase the speed of processing.

The operating system 20 may be Linux-based or other known operating system or an operating system especially designed for the system.

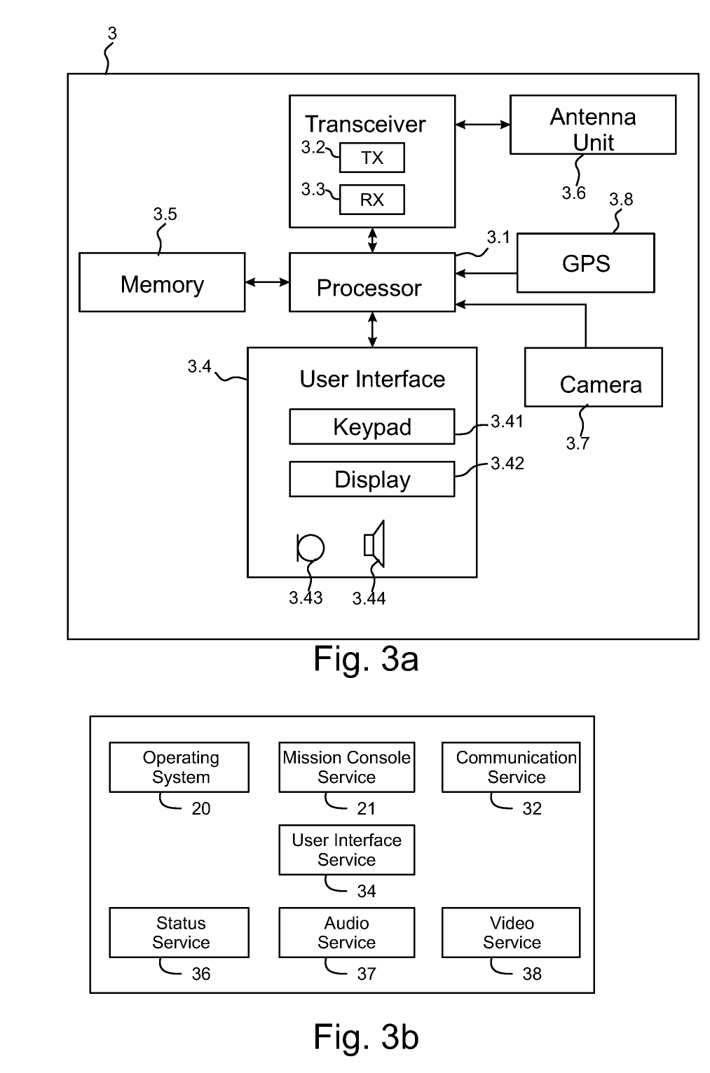

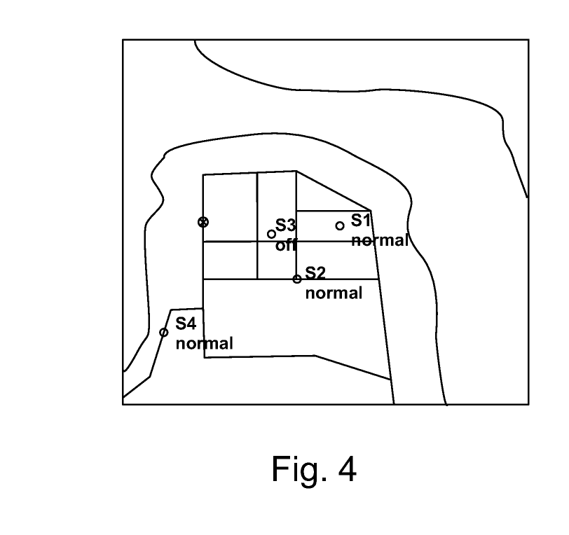

FIG. 3a depicts a block diagram of an example embodiment of the client device 3. The client device 3 comprises a processor 3.1 for controlling the operations of the client device 3. The client device 3 also comprises communication means such as a transmitter 3.2 and a receiver 3.3 for communicating with other devices in the system 1. The client device 3 further comprises a user interface 3.4 for providing means 3.41 to input data (e.g. a keyboard) by a user to the client 3 and means 3.42 to display data (e.g. a display) to the user. The user interface 3.4 may also comprise a microphone 3.43 for inputting audio information such as speech, and a loudspeaker 3.44 for providing audio information to the user of the client device. There is also a memory 3.5 for storing data and program code. The memory 3.5 may comprise different kinds of memory such as volatile memory and non-volatile memory.

In some embodiments the client device 3 may further comprise a camera 3.7 for taking pictures and capturing videos.

In some embodiments the client device 3 comprises a positioning receiver 3.8 for obtaining information of the location of the client device 3. The positioning receiver 3.8 may be, for example, a global positioning system (GPS) receiver. Also the master device 2 may comprise a positioning receiver for obtaining information of the location of the master device 2. In some embodiments the position of the master device 2 and/or the client device 3 may be obtained by using WLAN, WiFi or other wireless communication networks.

It is also possible to provide some of the functionality with external peripherals like a camera, e.g. a helmet camera, a global positioning system (gps) receiver, and potentially also other sensors.

In FIG. 3b an example of some further elements of the communication device capable of operating as the client device are depicted as a simplified block diagram. In this example embodiment the client device 3 has an operating system 20, the mission console service 21, a client communication service 32, a client user interface service 34, a status service 36, an audio service 37, and a video service 38. Also other services may be implemented in the communication device. The services may be implemented as a computer instructions which when performed by a processor 3.1 of the communication device cause the communication device to perform steps determined by the computer instructions. The computer instructions may be stored into a memory 3.5 of the communication device. Each of the services may be able to communicate with one or more of the other services or otherwise exchange information. The client user interface service 34 is able to receive commands and other information provided by the user of the communication device e.g. by using a keypad 3.41 and/or a touch screen of the communication device. The client user interface service 34 is also able to provide information to a display 3.42 and/or to a loudspeaker 3.44 of the communication device.

In some embodiments it is possible to use the master device 2 as the client and the client device 3 as the master device 2.

In some embodiments the system 1 may utilize an existing wireless communication network such as a mobile telephone network. The master device 2 and the client 3 may then be, for example, mobile phones.

In the following the operation of the system 1 is described in more detail. The client devices 3 of the system 1 may have different properties or different requirements in the system 1. Therefore, different roles or different tasks may have been defined for different purposes. For example, some clients may be used as camera surveillance devices and some other clients may be used for receiving commands from a headquarter or from other command centre and for providing information from the location of the client by the user of the client. For example, a leader of a squad may inform the command centre the progress of the squad and activities detected around the location of the squad.

Different tasks may be provided different priorities. In other words, more important tasks may obtain higher priority than some less critical tasks. The master device 2 may utilize the priorities defined for different tasks in managing the bandwidth reserved for the client devices 3.

In some embodiments, when the system 1 is established the user of the server 9 may define which devices are used as master devices 2, as client devices 3, etc. The server 9 may store a table in a memory of the server in which the identifiers of the devices in the system are stored as well as some other information relating to the devices. The information may include a name of the device, a name of the group or groups to which the device belongs, etc. The server 9 may also store information on the hierarchy of the system. For example, information on the squad, platoon, company etc. the devices belong. Information on the squad, platoon, company etc. may be included in the identifier wherein a certain part or parts of the identifier may indicate the squad, platoon, company etc. and it may be possible to collect data from or to provide data to all devices belonging to a certain squad, platoon, company etc. by utilizing that part or those parts in which this information has been stored.

The system 1 may not remain the same all the time but some new communication devices may be added to the system and/or some of the communication devices may be removed from the system. Therefore, the information stored to the server 9 may be changed accordingly. Also information on changes in the system configuration or in a part of the system configuration may be delivered to the lower levels in the hierarchy of the system 1.

In the illustrative example of the system in FIG. 1b the system 1 comprises two first level master devices 2 each controlling a set of client devices 3, another master devices 5, 8 at the next higher levels, and a central device 9. The central device 9 may be located e.g. in a headquarters of the military troops. The first level master device 2 is in communication with the second level master device 5 and with client devices 3 in the first set 7a of client devices. The second level master device 5 is in communication with the third level master device 8 and with possible other first level master devices 2. The third level master device 8 may be communicating with the central device 9 and with other second level master devices 5, if any. The first set 7a of clients may contain client devices carried by military personnel belonging to a first squad and the second set 7b of clients may contain client devices carried by military personnel belonging to a second squad. One of the first level master devices 2 may be under control of a leader of the first squad and another one of the first level master devices 2 may be under control of a leader of the second squad, for example.

In some embodiments the client devices 3 may obtain information relating to the status of the client device 3, to the location of the client device 3 etc. The client device 3 may also capture video and/or snapshot pictures by the camera 3.7 and also audio signals e.g. by the microphone 3.43. The captured video and/or audio signals may be transmitted by the client device 3 to the master device 2. The transmission may be initiated by a command sent by the master device 2 or by instructions given by the user of the client device 3. In some embodiments the capturing and/or transmission of video/audio signals may be initiated by an alarm or by a predetermined condition. For example, the client device 3 captures audio by the microphone and the audio service 37 of the client device analyses the signals formed by the microphone. When the audio service 37 determines that the signal contains indication of voice in the environment of the client device 3, the audio service 37 may then instruct the client communication service 33 to begin transmission of video and/or audio signals to the master device 2. In some embodiments the video service 38 may examine captured video signal to detect possible changes in the contents of the video signal e.g. by comparing values of some or all pixels in one frame to values of corresponding pixels in a successive frame and if changes in the pixel values exceed a predetermined value, the video service 38 may conclude that there is some movement in the view of the camera unit. Hence, the video service 38 may then instruct the client communication service 33 to begin transmission of video and/or audio signals to the master device 2.

Another example of using a predetermined condition to initiate transmission of some information from the client device 3 to the master device is related to the position of the client device 3, For example, the client device 3 may periodically transmit information of the location of the client device 3 to the master device 2. The master device 2 may use the location information to determine the distance of the client device 3 from the master device 2 and if the distance exceeds a determined limit the master device 2 may send a message to the client device 3 to command the client device 3 to begin transmission of e.g. video and/or audio to the master device 2.

Yet another example relates to the status of the battery of the client device 3. If the client device 3 detects that the charge level in the battery drops below a threshold, the client device 3 may transmit status information, Information on the current location of the client device 3 and/or some other information to the master device 2.

The master device 2 may collect different kinds of information from client devices 3 of the group which is controlled by the master device 2. The master device 2 do not usually forward all the collected information to the communication device at a higher level in the hierarchy but the master device 2 filters the information and/or forms some statistical analyses and/or some other kind(s) of collective bunch of information based on the information received from the client devices 3. This is due to the fact that on the higher levels of the hierarchy the information related to a single client device 3 may not be of importance but the status of the whole group may be more informative on the higher hierarchy levels.

Similarly, when higher level commander(s) have decided some operations the commands from the higher level may be transmitted to the next lower level in which the commands are transformed to more detailed operations within the group so that the lower level commander instructs each unit (e.g. soldiers) to perform some tasks. In other words, command messages from higher levels are not delivered as such to the client devices 3 at the lowest level but different kinds of “sub-command” messages may be formed e.g. by the master devices which receives the command messages.

The master device(s) 2 may monitor communication activity in the area of the master device 2 to determine how much communication capacity can be used by the system. In some situations there may be other communication systems which may also reserve some communication capacity in the area if the other communication systems utilize similar radio frequencies and communication technologies than the system 1. Although there weren't any other communication systems which could reserve some communication capacity from the system 1 the communication capacity provided for the system 1 may still require some management especially when more than one client 3 have information to be transmitted to the master device 2. The master device 2 may then provide different bandwidth to different clients 3. In some embodiments the client devices 3 which have information to be transmitted may request bandwidth from the master device 2. The information to be transmitted may belong to a task running in the client 3. The master device 2 receives the request(s) and examines the table 2 to determine which of the requests has the highest priority and provides more bandwidth for the client device 3 in which the highest priority task is running and requesting bandwidth. The request may include identification information of the identity of the sender of the request may be determined by a logical communication channel in which the request was transmitted. For example, in TDMA-based systems each client device 3 may be provided a certain time slot to transmit the requests to the master device 2 wherein the master device 2 can distinguish different client devices on the basis of the time slot.

The bandwidth management may take into account the priority of messages from client devices 3, the overall bandwidth available at the region, etc.

A non-limiting example of the table 2 is shown below. The table 2 contains information on the identity of a device from which a request for bandwidth for communication may have been received, the priority of the request and the status of the request. The table 2 may also contain information on messages transmitted or waiting for transmission from the server to the client(s) wherein the status may indicate if the message has been transmitted to the client(s), if the client(s) has/have responded to the request, etc.

TABLE 2

| Dev_ID | Type | Priority | Status |
|---|---|---|---|
| 1001 | Request bandwidth | 2 | Waiting |
| 1002 | Status message | 1 | Received |
| 1003 | Status request to | 0 | Wait for the |
| | client | | reply |
| 1004 | Set parameters | 3 | Waiting |
| 1003 | Request bandwidth | 0 | Waiting |

The bandwidth provided for client devices 3 may vary at different moments of time. For example, when communication request from a task having a high priority have been served another client device 3 in which another communication request from a task having lower priority is pending may then be provided more bandwidth and the bandwidth reserved for the client running the higher priority task may be reduced.

As was described above the master device 2 may manage bandwidth to be provided to client devices 3 in the set of client devices 7a, 7b which the master device 2 communicates with. The master device 2 may also be able to configure the status of all the client devices in the set of client devices 7a, 7b at once. For example, the master device 2 may transmit a command in which all the client devices 3 in the set 7a, 7b of client devices are set to a passive state, to an active state or to another state. The master device 2 may also provide the same bandwidth to all the client devices 3 in the set 7a, 7b of clients if the master device 2 determines that it is possible and suits well to a current situation. In some example situations the master device 2 may also transmit a command in which all or some of the client devices 3 in the set 7a, 7b of client devices are set to capture snap shot images or video and send the images or video to the master device 2 at appropriate moments of time.

In some embodiments the master device 2 stores at least some information communicated between the client devices 3 and the master device. This information may be retrieved at a later stage and examined and/or transmitted to the central device 9.

In some embodiments the master device 2 automatically controls information received from the client devices 3 and when it detects that a predetermined condition is fulfilled the master device 2 may generate e.g. an alarm. The alarm may be indicated by the user interface 2.4 of the master device 2 and/or transmitted to the central device 9.

In some embodiments the same client device 3 may have different tasks with different importance (priority). Hence, the client device 3 may be provided different bandwidth in different situations. For example, if a task with higher priority needs to communicate with the master device 2, the master device 2 may try to reserve more bandwidth for the client device 3 to serve the request. As an example, the client device 3 may be instructed to send information of the location of the client device 3 at regular intervals, which may not need much communication capacity, and also to send images or video captured by the camera 3.7 of the client device 3. The master device 2 may also have defined that the client device 3 should send the images or video when a determined condition is fulfilled, for example if some audible sounds have been detected by the microphone 3.43 of the client device 3 or movement is detected in the image information captured by the camera 3.7. In such a situation the client device 3 may need more bandwidth to send the image information, wherein the master device 2 may try to reserve more communication capacity for the client device 3 to send the images. In another situation or if enough communication capacity is not available the master device 2 may instruct the client device 3 to send the images with less resolution or send only a part of the frames of the video.

The master device 2 and the client device 3 may comprise one or more message buffers arranged in the memory 2.5, 3.5 in which information to be transmitted may be stored to wait the actual transmission of the information. In some situations the message buffer may be attached with information on the priority of messages in the message buffer wherein the data transmission software of the master device 2/client device 3 may examine the priority to determine which message to transmit first. There may also be information of the validity of the message which may be used in situations in which a message has been waited for transmission and when the message could be transmitted, the validity may indicate that the message is no longer valid (e.g. the message is an old image and a newer image has already been transmitted from the device 2, 3).

In some embodiments the information transmitted between the master device 2 and the client devices 3 may be performed by using e.g. short messages (SMS), packet data transfer, circuit switched connection, and/or some other appropriate method.

The above described bandwidth management and client management principles are also applicable to other kinds of situations which may occur in the system 1.

The military organization is only one example of an organization in which the hierarchical communications system can be implemented. Other possible organizations for utilizing some embodiments of the present invention are, for example, police forces, hospitals, factories, transportation companies, and other organizations in which information gathering, filtering and transferring to higher levels in the organization would be desired.

The processor 2.1, 3.1 or some other form of generic central processing unit (CPU) or special-purpose processor such as digital signal processor (DSP), may operate to control the various components of the device 2, 3, 5 in accordance with embedded software and/or firmware stored in memory 2.5, 3.5 and/or stored in memory contained within the processor 2.1, 3.1 itself. In addition to the embedded software or firmware, the processor 2.1, 3.1 may execute other applications or application modules stored in the memory 2.5, 3.5 or made available via wireless network communications. The application software may comprise a compiled set of machine-readable instructions that configures the processor 2.1, 3.1 to provide the desired functionality, or the application software may be high-level software instructions to be processed by an interpreter or compiler to indirectly configure the processor 2.1, 3.1.

The transceiver is for bidirectional wireless communications with a local communications network. In some embodiments, the transceiver, portions of an antenna unit 2.6, 3.6, and an analog baseband processing unit may be combined in one or more processing units and/or application specific integrated circuits (ASICs). The antenna unit 2.6, 3.6 may be provided to convert between wireless signals and electrical signals, enabling the device 2, 3, 5 to send and receive information from other devices of the system 1. The antenna unit 2.6, 3.6 may include antenna tuning and/or impedance matching components, RF power amplifiers, and/or low noise amplifiers.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method for controlling communications in a communications system comprising:
operating at least one client device in the communications system;
communicating by a first master device with the at least one client device;
executing a communication management service in the first master device for controlling communications between the first master device and the at least one client device;
wherein the communication management service instructs the first master device to transmit identification information of the first master device and information of a group the first master device belongs to for reception by the at least one client device to inform the at least one client device (3) the identity and the group of the first master device.

2. The method according to claim 1, wherein the at least one client device not receiving the identification and group information within a predetermined period tries to receive identification and group information from another master device.

3. The method according to claim 2, wherein the client device not receiving the identification or group information within a predetermined period compares the identification and group information stored in the client device of an identification and group information of the client device to determine if the client device should become a new master device.

4. The method according to claim 3, wherein the client device which becomes the new master device begins to transmit the identification and group information of the client device to inform other client devices that the client device is the new master device.

5. The method according to claim 1 comprising defining a device hierarchy comprising at least a first level and a second level, wherein devices are assigned to at least one level of the device hierarchy.

6. (canceled)

7. The method according to claim 5, the device hierarchy further comprising a third level, wherein a second master device is operating on the third level and communicates with master devices on the second level.

8. The method according to claim 7, wherein the first master device receives status information from the client devices; uses the received status information to form a combined information; and provides the combined information to the second master device.

9. The method according to claim 1, wherein the first master device sends a command to the at least one client device to control the operation of the at least one client device.

10. The method according to claim 1, wherein the first master device manages bandwidth provided to the at least one client device.

11. The method according to claim 10, wherein the bandwidth management comprises at least one of the following:
examining a priority of a request from the at least one client device;
examining the bandwidth available for the communications in the communications system between the first master device and the at least one client device;
adapting the amount of information to be sent from the at least one client device to the first master device.

12. A system comprising means for controlling communications, the system comprising:
at least one client device comprising communication means to communicate with a first master device;
the first master device comprising communication means to communicate with the at least one client device; and
means for executing a communication management service in the first master device for controlling communications between the first master device and the at least one client device;
wherein the communication management service comprises means for instructing the first master device to transmit identification information of the first master device and information of a group the first master device belongs to for reception by the at least one client device to inform the identity and the group of the first master device to the at least one client device.

13. The system according to claim 12 further comprising means for transmitting at intervals the identification and group information of the first master device. wherein the at least one client device not receiving the identification and group information within a predetermined period is adapted to try to receive identification and group information of another master device.

14. The system according to claim 12, wherein the client device not receiving the identification or group information within a predetermined period is adapted to compare the identification and group information stored in the client device of an identification and group information of the client device to determine if the client device should become a new master device.

15. The system according to claim 14, wherein the client device which becomes the new master device is adapted to begin transmitting the identification and group information of the client device to inform other client devices that the client device is the new master device.

16. The system according to claim 12 comprising means for defining a device hierarchy comprising at least a first level and a second level, wherein devices have been assigned to at least one level of the device hierarchy.

17. (canceled)

18. The system according to claim 16, the device hierarchy further comprising a third level, wherein a second master device is adapted to operate on the third level and to communicate with master devices on the second level.

19. The system according to claim 18, further comprising:
means for receiving status information from the client devices;
means for using the received status information to form a combined information; and
means for providing the combined information to the second master device.

20. The system according to claim 19, wherein the first master device is adapted to send a command to the at least one client device to control the operation of the at least one client device.

21. The system according to claim 12, wherein the first master device comprises means for managing bandwidth provided to the at least one client device.

22. The system according to claim 21, wherein the means for managing bandwidth comprises at least one of the following:
means for examining a priority of a request from the at least one client device;
means for examining the bandwidth available for the communications in the communications system between the first master device and the at least one client device;
means for adapting the amount of information to be sent from the at least one client device to the first master device.

23. A master device for a communication system, the master device comprising:
a transceiver for receiving and transmitting data to and from at least one client device;
means for executing a communication management service for controlling communications between the master device and the at least one client device;
the communication management service comprising means for transmitting identification information of the master device and information of a group the master device belongs to for reception by the at least one client device to inform the identity of the master device and the group to the at least one client device.

24. The master device according to claim 23 adapted to transmit at intervals the identification and group information of the master device.

25. The master device according to claim 23 further comprising means for determining a device hierarchy comprising at least a first level and a second level, and means for using the device hierarchy to determine which client devices belong to a set of client devices the master device is configured to control.

26. The master device according to claim 25 adapted to operate in the second level.

27. The master device according to claim 25, the device hierarchy further comprising a third level, wherein the master device is adapted to communicate with a master device of the second level.

28. The master device according to claim 23, comprising:
means for receiving status information from the client devices;
means for using the received status information to form a combined information; and
means for providing the combined information to the master device of the second level.

29. The master device according to claim 21, wherein the first master device comprises means for managing bandwidth provided to the at least one client device.

30. The master device according to claim 29, wherein the means for managing bandwidth comprises at least one of the following:
means for examining a priority of a request from the at least one client device;
means for examining the bandwidth available for the communications in the communications system between the first master device and the at least one client device;
means for adapting the amount of information to be sent from the at least one client device to the first master device.

31. A client device for a communication system comprising:
a transceiver for receiving and transmitting data to and from a master device;
means for sending a request for communication to a server; and
means for receiving identification information of the master device and information of a group the first master device belongs to to determine the identity and group of the master device.

32. The client device according to claim 31 adapted to receive the identification and group information of the master device at intervals.

33. The client device according to claim 31 further comprising means for determining a device hierarchy comprising at least a first level and a second level, and means for using the device hierarchy to determine which master device is configured to control the client device.

34. The client device according to claim 31 adapted to operate in the first level.

35. The client device according to claim 31 adapted to receive a command from the master device to control the operation of the client device.

36. A computer program product comprising a computer-readable medium bearing computer program code embodied therein for use with a computer, the computer program code comprises code which when executed by the computer causes an apparatus to
receive and transmit data to and from at least one client device;
execute a communication management service for controlling communications between the master device and the at least one client device;
to transmit identification information of the master device and information of a group the master device belongs to for reception by the at least one client device to inform the identity and the group of the master device to the at least one client device.

37. A computer program product comprising a computer-readable medium bearing computer program code embodied therein for use with a computer, the computer program code comprises code which when executed by the computer causes an apparatus to
receive and transmit data to and from a master device;
send a request for communication to a server; and
receive identification information of the master device and information of a group the first master device belongs to to determine the identity and the group of the master device.

38. The method according to claim 1, comprising:
transmitting by the first master device identity and group information of devices operating in the same group;
receiving by the at least one client device the identity and group information of devices operating in the same group; and
storing the received information in the at least one client.

39. The system according to claim 12, wherein
the first master device comprises means for transmitting identity and group information of devices operating in the same group;
the at least one client device comprises:
means for receiving the identity and group information of devices operating in the same group; and
means for storing the received information.
